(19) United States
(12) Patent Application Publication
(10) Pub. No.: US 2010/0305948 A1
(43) Pub. Date: Dec. 2, 2010

(54) Phoneme Model for Speech Recognition

(76) Inventors: Adam Simone, Rehovot (IL); Roman Budnovich, Rishon le Zion (IL); Avraham Entelis, Rehovot (IL)

Correspondence Address: The Law Office of Michael E. Kondoudis, 888 16th Street, N.W., Suite 800, Washington, DC, 20006, US

(21) Appl. No.: 12/475,879

(22) Filed: Jun. 1, 2009

(51) Int. Cl. G10L 15/28

(52) U.S. Cl. 704/255; 704/E15.001

(57) ABSTRACT

A sub-phoneme model given acoustic data which corresponds to a phoneme. The acoustic data is generated by sampling an analog speech signal producing a sampled speech signal. The sampled speech signal is windowed and transformed into the frequency domain producing Mel frequency cepstral coefficients of the phoneme. The sub-phoneme model is used in a speech recognition system. The acoustic data of the phoneme is divided into either two or three sub-phonemes. A parameterized model of the sub-phonemes is built, where the model includes Gaussian parameters based on Gaussian mixtures and a length dependency according to a Poisson distribution. A probability score is calculated while adjusting the length dependency of the Poisson distribution. The probability score is a likelihood that the parameterized model represents the phoneme. The phoneme is subsequently recognized using the parameterized model.

### BACKGROUND

1. Technical Field

The present invention relates to speech recognition and, more particularly to a method for building a phoneme model for speech recognition.

2. Description of Related Art

A conventional art speech recognition engine typically incorporated into a digital signal processor (DSP), inputs a digitized speech signal, and processes the speech signal by comparing its output to a vocabulary found in a dictionary. Reference is now made to a conventional art speech processing system 10 illustrated in FIG. 1. In block 101, the input analog speech signal from microphone 416 is sampled, digitized and cut into frames of equal time windows or time duration, e.g. 25 millisecond window with 10 millisecond overlap. The frames of the digital speech signal are typically filtered, e.g. with a Hamming filter 103, and then input into a circuit 105 including a processor which performs a Fast Fourier transform (FFT) using one of the known FFT algorithms. After performing the FFT, the frequency domain data is generally filtered, e.g. Mel filtering to correspond to the way human speech is perceived. In conventional art speech processing systems, the choice of FFT algorithm produces a spectrum with Mel-frequency cepstral coefficients (MFCCs) 107.

Mel-frequency cepstral coefficients are commonly derived by taking the Fourier transform of a windowed excerpt of a signal to produce a spectrum. The powers of the spectrum are then mapped onto the mel scale, using overlapping windows. Differences in the shape or spacing of the windows used to map the scale can be used. The logs of the powers at each of the mel frequencies are taken, followed by the discrete cosine transform of the mel log powers. The Mel-frequency cepstral coefficients (MFCCs) are the amplitudes of the resulting spectrum.

The mel-frequency cepstrum (MFC) is a representation of the short-term power spectrum of a sound, based on a linear cosine transform of a log power spectrum on a nonlinear mel scale of frequency. The mel scale, is a perceptual scale of pitches judged by listeners to be equal in distance from one another. The difference between the cepstrum and the mel-frequency cepstrum MFC is that in the MFC, the frequency bands are equally spaced on the mel scale, which approximates the human auditory system's response more closely than the linearly-spaced frequency bands used in the normal cepstrum.

The Mel-frequency cepstral coefficients (MFCCs) are used to generate voice prints of words or phonemes conventionally based on Hidden Markov Models (HMMs). A hidden Markov model (HMM) is a statistical model where the system being modeled is assumed to be a Markov process with unknown parameters, and the challenge is to determine the hidden parameters, from the observable parameters. Based on this assumption, the extracted model parameters can then be used to perform speech recognition. The model gives a probability of an observed sequence of acoustic data given a word phoneme or word sequence and enables working out the most likely word sequence.

In probability theory and statistics, the Poisson distribution is a discrete probability distribution that expresses the probability of a number of events occurring in a fixed period of time if these events occur with a known average rate and independently of the time since the last event. The probability P that there are l occurrences in an interval λ is given by Eq.1.

$$P ( l ; λ ) = \frac{{λ}^{l} {e}^{- λ}}{l !} \qquad Eq . 1$$

e is the base of the natural logarithm (e=2.71828)

l is the number of occurrences of an event—the probability of which is given by the distribution function. l! is the factorial of l

λ is a positive real number, equal to the expected number of occurrences that occur during the given interval. For instance, if the events occur on average 4 times per minute, and the number of events occurring in a 10 minute interval are of interest, the Poisson distribution is used with k=10×4=40.

A Gaussian mixture model Γ consists of a weighted sum of M Gaussian densities:

wᵢgᵢ(x₀) used to measure probability p for a feature vector, say x₀. Where

$$p ( {x}_{0} , Γ ) = {\sum }_{i = 1}^{M} {w}_{i} {g}_{i} ( {x}_{0} ) \qquad Eq . 2$$

The Gaussian mixture model Γ is defined by weights wᵢ, Gaussian functions gᵢ (x₀) and summation Σᵢ for i=1 to M and denoted as such in Eq.3

$$Γ {[ {w}_{i} , {g}_{i} ( {x}_{0} ) , {\sum }_{i} ]}_{i = 1}^{M} \qquad Eq . 3$$

With the log-likelihood (i.e. a score) of a sequence of T vectors, X={x₁, . . . ,x_{T}} given by Eq.4 which is a score equation.

$$log ( p ( X , Γ ) ) = {\sum }_{t = 1}^{T} log ( p ( {x}_{t} , Γ ) ) \qquad Eq . 4$$

During the training of the Gaussian mixture module Γ, an update of the Gaussian mixture model shown by equation Eq.3 for example is denoted by Eq.5.

$${[ {\hat{w}}_{i} , {\hat{g}}_{i} ( {x}_{0} ) , {\sum }_{i} ]}_{i = 1}^{M} \qquad Eq . 5$$

The additional notation (‘̂’) in Eq.5 represents the updated states of the initial Gaussian mixture model Γ after a training step or steps.

TIMIT is a corpus of phonemically and lexically transcribed speech of American English speakers of different sexes and dialects. Each transcribed element has been delineated in time. TIMIT was designed to further acoustic-phonetic knowledge and automatic speech recognition systems. It was commissioned by DARPA and worked on by many sites, including Texas Instruments (TI) and Massachusetts Institute of Technology (MIT), hence the corpus' name. The 61 phoneme classes presented in TIMIT can been further collapsed or folded into 39 classes using a standard folding technique by one skilled in the art.

Reference is now made to FIG. 6 which illustrates schematically a simplified computer system 60 according to conventional art. Computer system 60 includes a processor 601, a storage mechanism including a memory bus 607 to store information in memory 609 and a network interface 605 operatively connected to processor 601 with a peripheral bus 603. Computer system 60 further includes a data input mechanism 611, e.g. disk drive for a computer readable medium 613, e.g. optical disk. Data input mechanism 611 is operatively connected to processor 601 with peripheral bus 603. Operatively connected to peripheral bus 603 is sound card 614. The input of sound card 614 operatively connected to the output of microphone 416.

In human language, the term “phoneme” as used herein is a part of speech that distinguishes meaning or a basic unit of sound that distinguishes one word from another in one or more languages. An example of a phoneme would be the ‘t’ found in words like “tip”, “stand”, “writer”, and “cat”. The term “sub-phoneme” as used herein is a portion of a phoneme found by dividing the phoneme into two or three parts.

The term “frame” as used herein refers to portions of a speech signal of substantially equal durations or time windows.

The terms “model” and “phoneme model” are used herein interchangeably and used herein to refer to a mathematical representation of the essential aspects of acoustic data of a phoneme.

The term “length” as used herein refers to a time duration of a “phoneme” or “sub-phoneme”.

The term “iteration” or “iterating” as used herein refers to the action or a process of iterating or repeating, for example; a procedure in which repetition of a sequence of operations yields results successively closer to a desired result or to the repetition of a sequence of computer instructions a specified number of times or until a condition is met.

A phonemic transcription as used herein is the phoneme or sub-phoneme surrounded by single quotation marks, for example ‘aa’.

### BRIEF SUMMARY

According to an aspect of the present invention there is provided a method for preparing a sub-phoneme model given acoustic data which corresponds to a phoneme. The acoustic data is generated by sampling an analog speech signal producing a sampled speech signal. The sampled speech signal is windowed and transformed into the frequency domain producing Mel frequency cepstral coefficients of the phoneme. The sub-phoneme model is used in a speech recognition system. The acoustic data of the phoneme is divided into either two or three sub-phonemes. A parameterized model of the sub-phonemes is built, in which the model includes multiple Gaussian parameters based on Gaussian mixtures and a length dependency according to a Poisson distribution. A probability score is calculated while adjusting the length dependency of the Poisson distribution. The probability score is a likelihood that the parameterized model represents the phoneme. The phoneme is typically subsequently recognized using the parameterized model. Each of the two or three sub-phonemes is defined by a Gaussian mixture model probability density function Pⁱ, with Poisson length dependency P(l; λ):

$$P = [ {\sum }_{i = 1}^{f} {P}^{i} ] \times [ P ( l ; λ ) ] \qquad Eq . 6$$

The sampled speech signal is framed to produce multiple frames of the sampled speech signal. The summation Σ is over the number f of frames of the sub-phoneme. The characteristic length λ is the average of the sub-phoneme length l in frames from the acoustic data. The dividing of the acoustic data and the calculating of the probability score equation are iterated until the probability score approaches a maximum. With the probability score at a maximum the Gaussian parameters of the parameterized model are updated. The parameterized model is stored when the characteristic length converges.

According to the present invention there is provided a method of preparing a sub-phoneme model given acoustic data corresponding to a phoneme, for use in a speech recognition system. The acoustic data of the phoneme is divided into either two or three sub-phonemes. A parameterized model of the sub-phonemes is built. The model includes Gaussian parameters based on Gaussian mixtures and a length dependency according to a Poisson distribution.

According to another aspect of the present invention there is provided a computer readable medium encoded with processing instructions for causing a processor to execute the method.

### BRIEF DESCRIPTION OF THE DRAWINGS

The invention is herein described, by way of example only, with reference to the accompanying drawings, wherein:

FIG. 1 shows a conventional art speech processing system.

FIG. 2a shows a system for obtaining a phoneme model via a training method and recognition of a phoneme subsequent to the training, according to an embodiment of the present invention.

FIG. 2b shows a system for recognizing phonemes using the sub-phonemes stored of FIG. 2a.

FIG. 3a shows a typical graph of amplitude (arbitrary units) versus time (arbitrary units) for speech showing phoneme ‘aa’ according to an embodiment of the present invention.

FIG. 3b shows further details of the phoneme ‘aa’ divided into 3 sub-phonemes according to an embodiment of the present invention.

FIG. 4 shows a method for optimizing a phoneme model according to an embodiment of the present invention.

FIG. 5 shows how a maximizing probability path of a phoneme divided into three equal sub-phonemes for speech recognition according to an exemplary embodiment of the present invention.

FIG. 6 illustrates schematically a simplified computer system according to conventional art.

The foregoing and/or other aspects will become apparent from the following detailed description when considered in conjunction with the accompanying drawing figures.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, an embodiment of the present invention is directed toward optimally dividing a phoneme into either 2 or 3 sub-phonemes not dependent on a word or sentence model. Consequently as a result of dividing a phoneme into either 2 or 3 divisions, a set of 130 to 150 sub-phonemes are produced independent of a particular language and may be used for subsequent speech recognition.

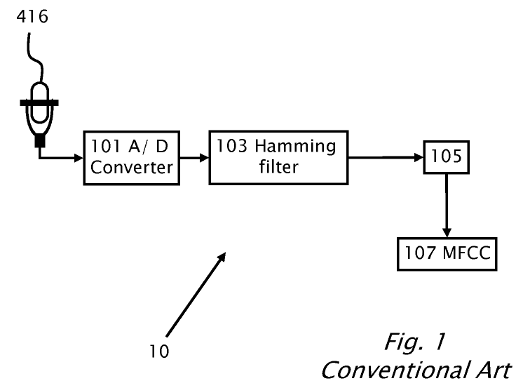

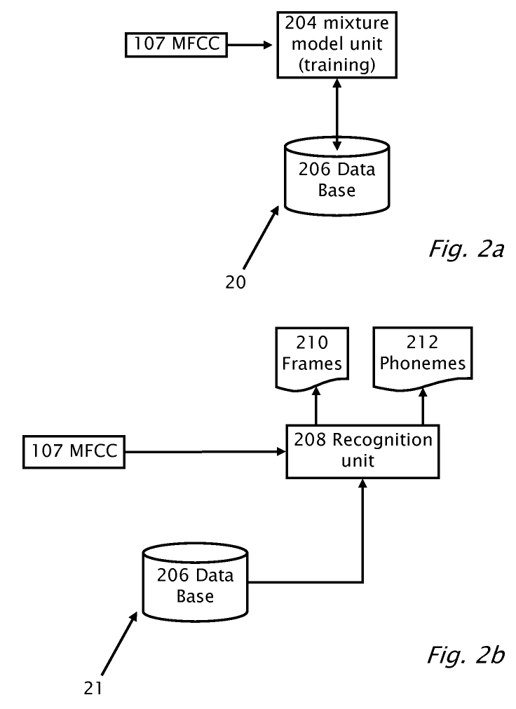

Reference is now made FIG. 2a which shows a system 20 for obtaining a phoneme model via a training method 204, according to an embodiment of the present invention. Mel-frequency cepstral coefficients (MFCC) 107 (FIG. 1) are input to a mixture module 204. Mixture module unit 204 outputs to data base 206. The phoneme model obtained via training method 204 and mixture model unit 204 is preferably a Gaussian mixture model. Mel-frequency cepstral coefficients (MFCC) 107 (FIG. 1) have preferably been derived using a Hamming-Cosine window with a 16-8 KHz transform with anti-aliasing.

Reference is now made to FIG. 2b which shows a system 21 for recognizing phonemes using the sub-phonemes stored in data base 206 of FIG. 2a. Mel-frequency cepstral coefficients (MFCC) 107 (FIG. 1) are input to a recognition unit 208. Recognition unit 208 receives an additional input from the output of data base 206. Recognition unit 208 has two outputs; and the recognized phonemes and/or sub-phonemes 212 and their length in frames 210.

Recognition of a phoneme represented by the input of mel-frequency cepstral coefficients (MFCC) 107 (FIG. 1) is performed by by recognition unit 208 by comparing the phoneme with phoneme/sub-phoneme models stored in data base 206.

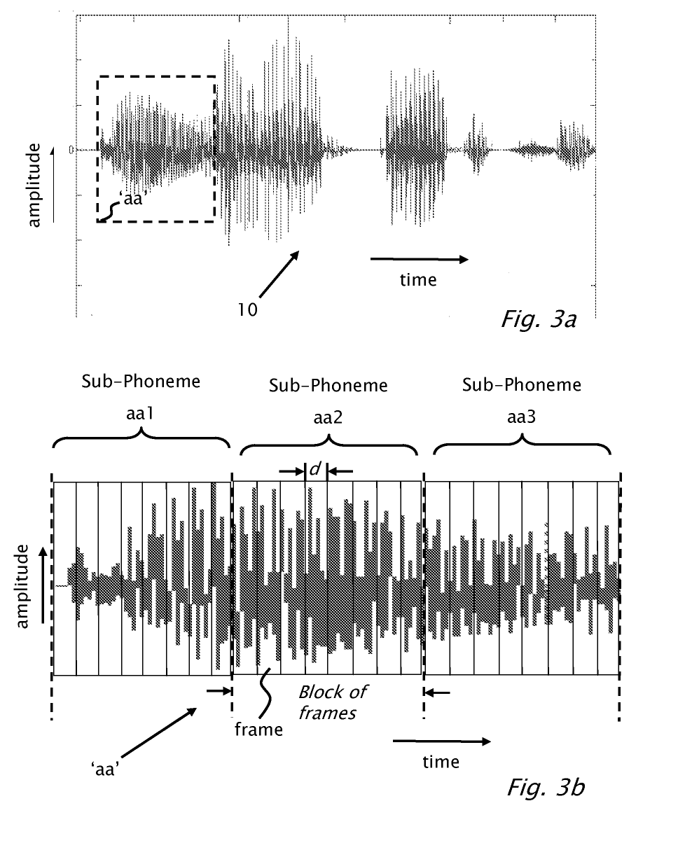

FIG. 3a shows a typical graph 10 of amplitude (arbitrary units) versus time (arbitrary units) for a speech signal which shows a phoneme ‘aa’. FIG. 3b shows phoneme ‘aa’ divided into three sub-phonemes; ‘aa1’, ‘aa2’ and ‘aa3’ according to an embodiment of the present invention. In FIG. 3b, each sub-phoneme has a block of frames f with each frame having approximately equal length d.

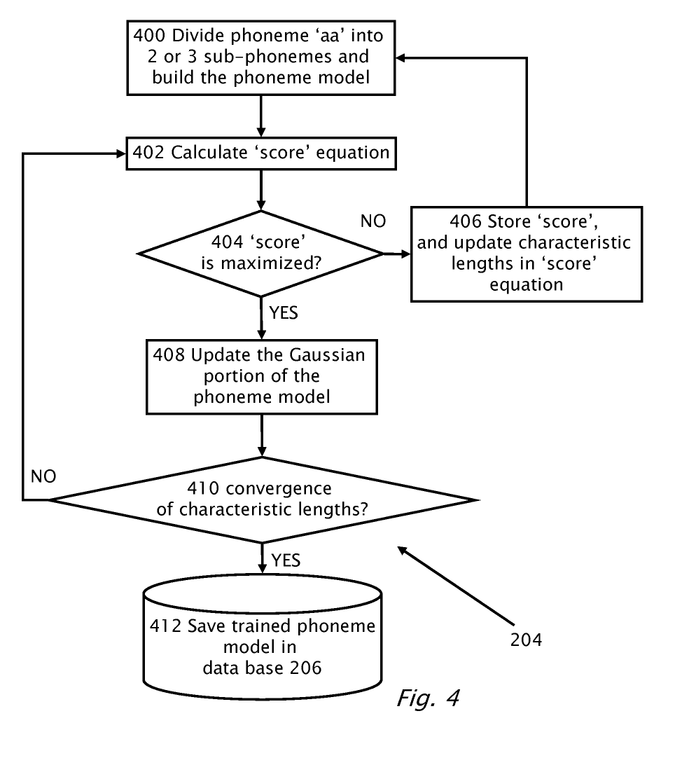

Reference is now made to FIG. 4 illustrating training method 204 for obtaining the phoneme model according to an embodiment of the present invention. In an exemplary embodiment of the present invention, phonemes are in accordance with the 61 phoneme classes of TIMIT folded into 39 categories of classification and phonemes are divided into either 2 or 3 divisions.

Phonemes of the folded TIMIT database are input to conventional system 10 which outputs mel-frequency cepstral coefficients (MFCC) coefficients corresponding to the phonemes input from the TIMIT speech corpus.

The phonemes are modeled with two or three sub-phonemes. Probability density function P_{z} is used for the state probability density functions for each phoneme including Gaussian mixture model probability density functions, Pⁱ₁, and Pⁱ₂ (for 2 sub-phonemes) with Poisson length dependency (P(l₁; λ₁), P(l₂; λ₂)) of 2 sub-phonemes shown in equation Eq.7. Probability density function P_{z} is used for the state probability density functions for each phoneme including Gaussian mixture model probability density functions, Pⁱ₁, Pⁱ₂ and Pⁱ₃ (for 3 sub-phonemes) with Poisson length dependency (P(l₁; λ₁), P(l₂; λ₂), P(l₃; λ₃)) of 3 sub-phonemes shown in equation Eq.8. Probability density function P_{z} is determined for all frames f of each sub-phoneme (either 2 or 3 sub-phonemes) in equations Eq.7 and Eq.8.

$$\begin{matrix}{P}_{z} = [ {\sum }_{i = 1}^{f} {P}_{1}^{i} \times {\sum }_{i = 1}^{f} {P}_{2}^{i} ] \times [ P ( {l}_{1} ; {λ}_{1} ) \times P ( {l}_{2} ; {λ}_{2} ) ] ( for 2 sub \text{-} phonemes ) & Eq . 7 \\ {P}_{z} = [ {\sum }_{i = 1}^{f} {P}_{1}^{i} \times {\sum }_{i = 1}^{f} {P}_{2}^{i} \times {\sum }_{i = 1}^{f} {P}_{3}^{i} ] \times [ P ( {l}_{1} ; {λ}_{1} ) \times P ( {l}_{2} ; {λ}_{2} ) \times P ( {l}_{3} ; {λ}_{3} ) ] & Eq . 8\end{matrix}$$

(for 3 sub-phonemes)

Sub-phoneme probabilities Pⁱ₁, Pⁱ₂ and Pⁱ₃ correspond to the Gaussian mixture model of equation Eq.3, such that each sub-phoneme had its own Gaussian mixture model i.e. for Pⁱ₁ for example in Eq.9

$${P}^{{i}_{1}} = p ( {x}_{0} , Γ ) = {\sum }_{i = 1}^{M} {w}_{i} {g}_{i} ( {x}_{0} ) \qquad Eq . 9$$

A score equation is obtained by taking logs of both sides of equations Eq.7 and Eq.8, giving equation Eq.10 for a 2 sub-phoneme division of a phoneme and equation Eq.11 for a 3 sub-phoneme division of a phoneme. Probability score equations Eq.10 and Eq.11 and the phoneme model are embedded with the acquired acoustic data (for example amplitude, time/frequency, frames, blocks of frames, Mel-frequency cepstral coefficients 107) characterizing each sub-phoneme (‘aa1’, ‘aa2’ and ‘aa3’) obtained using system 20.

$$\begin{matrix}Score = [ {\sum }_{i = 1}^{i = f} log ( {P}_{1}^{i} ) + {\sum }_{i = 1}^{i = f} log ( {P}_{2}^{i} ) ] + [ log ( {P}_{1} ( {l}_{1} ; {λ}_{1} ) ) + log ( {P}_{2} ( {l}_{2} ; {λ}_{2} ) ) ] & Eq . 10 \\ Score = [ {\sum }_{i = 1}^{i = f} log ( {P}_{1}^{i} ) + {\sum }_{i = 1}^{i = f} log ( {P}_{2}^{i} ) + {\sum }_{i = 1}^{i = f} {P}_{3}^{i} ] + [ log ( {P}_{1} ( {l}_{1} ; {λ}_{1} ) ) + log ( {P}_{2} ( {l}_{2} ; {λ}_{2} ) ) + log ( {P}_{3} ( {l}_{3} ; {λ}_{3} ) ) ] & Eq . 11\end{matrix}$$

In probability score equations Eq.10 and Eq.11, probabilities Pⁱ₁, Pⁱ₂ and Pⁱ₃ are found for a mixture model for sub-phonemes; ‘aa1’, ‘aa2’ and ‘aa3’ respectively. Probabilities Pⁱ₁, Pⁱ₂ and Pⁱ₃ are summed over all frames for each block of frames corresponding to sub-phonemes ‘aa1’, ‘aa2’ and ‘aa3’. Probabilities Pⁱ₁, Pⁱ₂ and Pⁱ₃ are derived in a first iteration of the division (step 400) of phoneme ‘aa’ into 3 sub-phonemes of for instance approximately equal length. Probabilities Pⁱ₁, Pⁱ₂ and Pⁱ₃ in subsequent iterations are used to for subsequent divisions (step 400) of the phoneme model into 3 sub-phonemes.

P₁ (l₁; λ₁), P₂ (l₂; λ₂) and P₃ (l₃; λ₃) in Eq.10 and Eq.11 represent the Poisson probability distribution functions for ‘aa1’, ‘aa2’ and ‘aa3’ respectively with lengths l₁, l₂ and l₃ being equal to the number of frames in each block and with characteristic lengths λ₁, λ₂ and λ₃ being the sum of the lengths d of each frame divided by the number of frames in each block.

Once the division of phoneme ‘aa’ into 3 sub-phonemes and a build of the phoneme model (step 400) is performed, the probability score value is calculated using probability score equation Eq.11 (step 402) for all sub-phonemes and frames using lengths l₁, l₂ and l₃ determined in step 400. The value of the probability score equation Eq.11 is checked (decision box 404) to see if the value of the probability score equation Eq.11, for new values of lengths l₁, l₂ and l₃, is maximized when compared to previous score calculations (step 402). If the probability score value of Eq.11 is not maximized (decision box 404) then characteristic lengths λ₁, λ₂ and λ₃ are updated (step 406) according to the length (l₁, l₂ or l₃) that maximizes the score equation (Eq.7) and the division (step 400) is repeated over all frames for each block of frames corresponding to sub-phonemes ‘aa1’, ‘aa2’ and ‘aa3’.

Once the score calculation is maximized, the phoneme model is further refined by updating (step 408) the Gaussian mixture models in equations Eq.7 and Eq.8 i.e. updating; Pⁱ₁, Pⁱ₂ and Pⁱ₃. Using equation Eq.8 for example Pⁱ₁, Pⁱ₂ and Pⁱ₃ are updated by summing for all frames using the characteristic lengths l₁, l₂ and l₃ of Poisson distributions P₁(l₁; λ₁), P₂(l₂; λ₂) and P₃(l₃; λ₃).

The updated phoneme model (step 408) is compared (decision box 410) to the phoneme model created originally in step 400. If there is no convergence between the values of characteristic lengths λ₁, λ₂ and λ₃ used for the phoneme model in step 400 and the values of characteristic lengths λ₁, λ₂ and λ₃ used to update the phoneme model in step 408, then step 402 is repeated.

Subsequent comparisons in step 410 are between the update in step 408 and the storage done in step 406. Once there is a convergence of characteristic length (λ₁, λ₂ and λ₃) values between the present phoneme model (built in step 408) and the previous phoneme model (built in step 400), the training step for the phoneme model is complete and the phoneme model is stored in data base 206 (step 412).

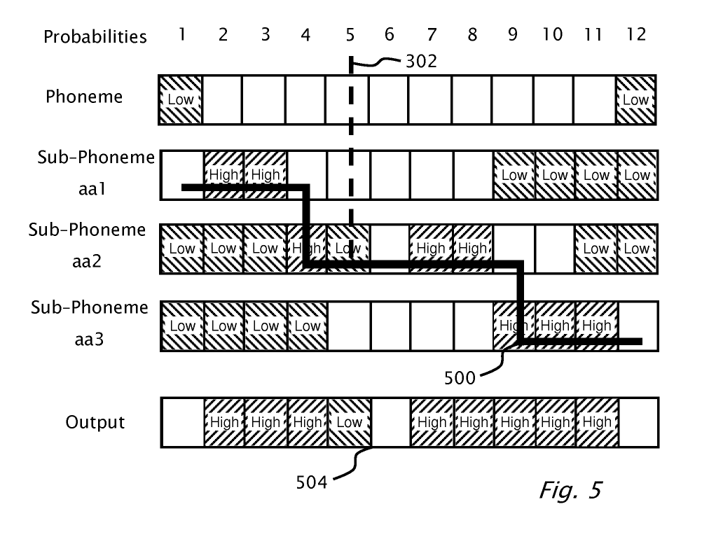

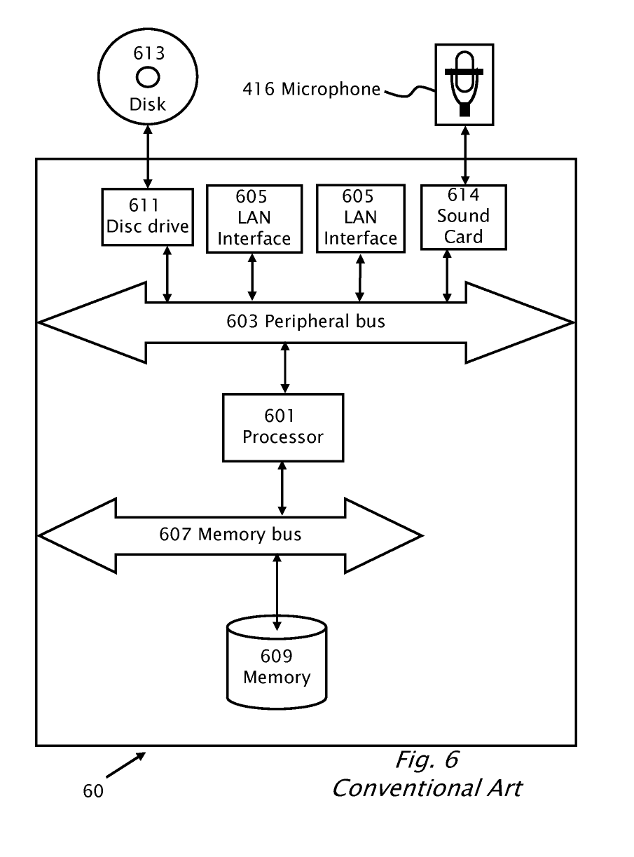

Reference is now made to FIG. 5 which illustrates graphically a maximum probability path 500 of recognizing a phoneme ‘aa’ which has been stored in data base 206 as divided into three sub-phonemes (‘aa1’, ‘aa2’ and ‘aa3’). In the example of FIG. 5, twelve frames are shown which are initially divided into four frames per sub-phoneme. Typically, phonemes to be recognized are input into recognition unit 208 according to their Mel frequency Cepstrum coefficients. Probabilities are illustrated graphically which correspond (in time) to 12 frames of phoneme ‘aa’.

According to a feature of the present invention, an initial step in recognizing a phoneme, e.g. ‘aa’ involves an appropriate selection of the beginning of frame 1 and the end of frame 12 which intends to accurately approximate the overall length of the phoneme to be recognized. This selection is based on the Poisson length dependencies found during training 204. While selecting the beginning of frame 1 and the end of frame 12, two separate probability scores are preferably used one for the start of the phoneme and one for the end of the phoneme with the obvious constraint that phoneme end occurs after the start of the phoneme.

A search is made for maximizing a probability path 500 which successfully puts path 500 of each phoneme (e.g. for ‘aa’) in time order of the 3 or 2 sub-phonemes as constructed from the stored Gaussian mixture module probability states with Poisson length dependencies. The probability states are probed over the frames of the whole incoming speech buffer. Referring to FIG. 5, starting at sub-phoneme ‘aa1’ block of frames, a series of probability peaks (for frames 1-4) is determined. Sub-phoneme ‘aa2’ block of frames has probability peaks (4-9 frames). While probability drops (such as in the 2nd frame in ‘aa2’ as marked by a dotted vertical line 302, the overall probability is compensated by the the first sub-phoneme ‘aa0’ in frame 6. The decision rule for transferring to the next sub-phoneme ‘aa2’ in order, is due to a probability drop of the current sub-phoneme ‘aa1’, and an increasing probability of the next sub-phoneme ‘aa2’ in order. A phoneme block is chosen as path 500 which successfully puts in time order the two or three 3 parts of the phoneme.

The definite articles “a”, “an” is used herein, such as “a sub-phoneme”, “a probability density function” have the meaning of “one or more” that is “one or more sub-phonemes” or “one or more probability density functions”.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A method of preparing a sub-phoneme model given acoustic data corresponding to a phoneme, wherein the acoustic data is generated by sampling an analog speech signal thereby producing a sampled speech signal, wherein the sampled speech signal is windowed and transformed into the frequency domain thereby producing Mel frequency cepstral coefficients of the phoneme, the sub-phoneme model for use in a speech recognition system, the method comprising:
dividing the acoustic data of the phoneme into selectably either two or three sub-phonemes; and
building a parameterized model of said sub-phonemes, wherein said model includes a plurality of Gaussian parameters based on Gaussian mixtures and a length dependency according to a Poisson distribution.

2. The method of claim 1, calculating a probability score while adjusting the length dependency of the Poisson distribution.

3. The method of claim 2, wherein said probability score is a likelihood that the parameterized model represents the phoneme.

4. The method of claim 1 further comprising:
recognizing the phoneme using the parameterized model.

5. The method of claim 1, wherein each of the said two or three sub-phonemes is defined by a Gaussian mixture model including a plurality of probability density functions Pⁱ, with Poisson length dependency P(l; λ):
$$P = [ {\sum }_{i = 1}^{f} {P}^{i} ] \times [ P ( l ; λ ) ] ,$$
wherein the sampled speech signal is framed thereby producing a plurality of frames of the sampled speech signal, wherein the summation Σ is over the number f of frames of the sub-phoneme, and wherein the characteristic length λ is the average of the sub-phoneme length l in frames from the acoustic data.

6. The method of claim 1 further comprising:
iterating said dividing and said calculating, wherein the probability score approaches a maximum.

7. The method of claim 6 further comprising:
updating the Gaussian parameters of the parameterized model;

8. The method of claim 7, wherein the characteristic lengths are the averages of the sub-phoneme lengths from the acoustic data, comprising:
storing the parameterized model when the characteristic length converges.

9. A method of preparing a sub-phoneme model given acoustic data corresponding to a phoneme, for use in a speech recognition system, the method comprising:
dividing the acoustic data of the phoneme into selectably either two or three sub-phonemes; and
building a parameterized model of said sub-phonemes, wherein said model includes a plurality of Gaussian parameters based on Gaussian mixtures and a length dependency according to a Poisson distribution.

10. A computer readable medium encoded with processing instructions for causing a processor to execute the method of claim 9.
